(19) United States
(12) Patent Application Publication
(10) Pub. No.: US 2025/0128633 A1
(43) Pub. Date: Apr. 24, 2025

(54) CHARGING SYSTEM AND CHARGING METHOD FOR ELECTRIC VEHICLE

(71) Applicants: HYUNDAI MOTOR COMPANY, SEOUL (KR); KIA CORPORATION, SEOUL (KR); HCHARGELAB INC., SEONGNAM-SI (KR)

(72) Inventors: Min Kyu Lee, Hwaseong-si (KR); Hotaek Lee, Hwaseong-si (KR); Younghoon Moon, Hwaseong-si (KR)

(73) Assignees: HYUNDAI MOTOR COMPANY, SEOUL (KR); KIA CORPORATION, SEOUL (KR); HCHARGELAB INC., SEONGNAM-SI (KR)

(21) Appl. No.: 18/920,137

(22) Filed: Oct. 18, 2024

(30) Foreign Application Priority Data
Oct. 19, 2023 (KR) 10-2023-0140587

(51) Int. Cl. B60L 53/66; B60L 53/68

(52) U.S. Cl. CPC B60L 53/665; B60L 53/68; B60L 2240/72

(57) ABSTRACT

An electric vehicle charging system including a host terminal on which a host application that receives instructions on an operating mode of a shared charger and an additional fee for use of the shared charger is installed; and a charging point operator server for calculating a charger usage fee based on a shared charging fee obtaining by adding a predetermined base fee to the additional fee provided from the host terminal, and a usage time of the shared charger by a user. The charging point operator server may receive, from a user terminal of the user, a sharing change request requesting a change of an operating mode of the shared charger to a sharing mode in which the public charger is available to the user, and transmit the sharing change request to the host terminal.

### CROSS REFERENCE TO RELATED APPLICATIONS

This application claims priority to and the benefit of Korean Patent Application No. 10-2023-0140587 filed in the Korean Intellectual Property Office on Oct. 19, 2023, the entire contents of which are incorporated herein by reference.

### BACKGROUND

### (a) Technical Field

The present disclosure relates to a charging system and a charging method for an electric vehicle.

### (b) Description of the Related Art

An electric vehicle charger is a necessary infrastructure for the widespread adoption of electric vehicles. The electric vehicle charger market is growing at a rapid pace. Electric vehicles may include plugged-in hybrid electric vehicles (Plugged-in HEV), battery electric vehicle (electric vehicle), and the like.

Public chargers, a type of electric vehicle charger, may only be used by users who are registered and authorized on a site operated by a charging point operator. The corresponding user pays the charging point operator a fee set by the charging point operator for using the public charger. The locations where public chargers are installed needs to be open. Information on the installation location and state of public chargers needs to be shared in order to receive subsidies from the Ministry of Environment. The charger business operator, who is responsible for public charger operation (fee collection, after-sales service (A/S), and the like), needs to establish a server for identifying user payment and charger state and to operate an A/S advice center. Many countries provide a certain amount of subsidies to public charger operators to promote the spread of electric vehicle chargers.

Among the electric vehicle chargers, unlike public chargers, non-public chargers are purchased and installed by individuals who wish to use the charger. Non-public chargers are operated by individuals, and may be limitedly used by the individuals who operate the non-public chargers. Government subsidies are not supported for non-public chargers. It is not permitted by law to provide charging services to others with a non-public charger.

Due to the high proportion of private land in urban centers, residential areas, and commercial districts, there are regional limitations to install public chargers, and the high cost of installation causes reduction of business values. Therefore, there are limitations to securing electric vehicle charging infrastructure of public chargers in areas, such as urban centers, residential areas, and commercial districts. To solve this problem, there is a need for common use of non-public chargers installed on a private land.

### SUMMARY

The present disclosure attempts to provide a charging system and a method for an electric vehicle, which reward individuals who provide non-public chargers to the public in order to share the non-public chargers.

An exemplary embodiment of the present disclosure provides an electric vehicle charging system, the electric vehicle charging system including a host terminal on which a host application that receives instructions on an operating mode of a shared charger and an additional fee for use of the shared charger is installed, and a charging point operator server for calculating a charger usage fee based on a shared charging fee obtaining by adding a predetermined base fee to the additional fee provided from the host terminal, and a usage time of the shared charger by a user.

The charging point operator server may receive, from a user terminal of the user, a sharing change request requesting a change of an operating mode of the shared charger to a sharing mode in which the public charger is available to the user, and transmit the sharing change request to the host terminal.

The charging point operator server may search for minimum distance chargers, which are shared and/or public chargers located within a predetermined minimum distance relative to the shared charger, calculate the number of minimum distance chargers searched and a first average fee for the usage fees of the minimum distance chargers, search for maximum distance chargers, which are shared and/or public chargers located within a predetermined maximum distance exceeding the minimum distance relative to the shared charger, calculate the number of maximum distance chargers searched and a second average fee for usage fees for the maximum distance chargers, and calculate a recommended charging fee based on the first average fee and the second average fee and transmits the recommended charging fee to the host terminal.

The charging point operator server may calculate the recommended charging fee by using the first average fee and a first distance weighted value for the minimum distance chargers, and the second average fee and a second distance weighted value for the maximum distance chargers.

The charging point operator server may calculate the recommended charging fee by adding a value obtained by multiplying the first average fee by the first distance weighted value and a value obtained by multiplying the second average fee by the second distance weighted value, and the first distance weighted value may be greater than the second distance weighted value.

The host application may, via an input/output device of the host terminal, display in stages the number of minimum distance chargers searched and the first average fee, the number of maximum distance chargers searched and the second average fee, and the recommended charging fee.

The charging point operator server may set a share of a first ratio and a share of a second ratio for the base fee and the additional fee as a profit of the charging point operator, and set a share of a third ratio and a share of a fourth ratio for the base fee and the additional fee as a profit of the host, and a sum of the first ratio and the third ratio and a sum of the second ratio and the fourth ratio each may be 1.

When an operating mode for the shared charger is a non-public mode, the charging point operator server may receive the sharing change request from the user terminal, and transmit a sharing request message to the host terminal in response to the sharing change request.

When a sharing mode change is received from the host terminal in response to the sharing request message, the charging point operator server may transmit a sharing mode changing message to the user terminal.

Another exemplary embodiment of the present disclosure provides an electric vehicle charging method of providing electric vehicle charging by using a shared charger installed by a host, the electric vehicle charging method including monitoring, by a charging point operator server, a state of the shared charger, when receiving a sharing change request for the shared charger from a user terminal, transmitting, by the charging point operator server, a sharing request message to a host terminal, receiving, by the charging point operator server, a sharing mode change from the host terminal, and transmitting a sharing mode change message to the user terminal, receiving, by the charging point operator server, a usage start time and a usage reservation request from the user terminal, receiving, by the charging point operator server, information about a charging start from the shared charger, and transmitting a usage start message to the host terminal, receiving, by the charging point operator server, information about a usage end and the amount of charging power from the shared charger, and calculating, by the charging point operator server, a charger usage fee based on the amount of charging power and a shared charging fec.

The electric vehicle charging method may further include transmitting, by the charging point operator server, information about the usage start time and the usage reservation to the host terminal.

The electric vehicle charging method may further include transmitting, by the charging point operator server, the charger usage fee to the host terminal and the user terminal in a form of a message.

The electric vehicle charging method may further include by the charging point operator server, detecting that an electric vehicle of a user is being parked in a charging area after a charging service end time that is elapsed by a predetermined time from a charging completion time; transmitting a parking notification message indicating that the electric vehicle of the user is being parked after charging is completed to the host terminal; and receiving a leaving request from the host terminal, and transmitting a leaving request message and a charging alarm message indicating that a parking fee is possibly charged to the user terminal.

The electric vehicle charging method may further include: by the charging point operator server, when a parking time reaches a threshold time, notifying the host terminal and the user terminal that the threshold time has elapsed and that a change to a non-public mode is to be made, calculating a final parking fee by counting a parking time of the electric vehicle of the user from the charging service end time to the time the electric vehicle of the user leaves, and charging the user for the calculated final parking fee, and transmitting the final parking fee to the host terminal.

The electric vehicle charging method may further include by the charging point operator server, receiving a fault detection from the shared charger, and transmitting a fault repair command for the shared charger to an associated terminal or server.

According to the exemplary embodiments of the present disclosure, by improving the profit structure that concentrates charging profits only on charging point operators (CPOs) who install and operate public chargers, individuals may install non-public chargers and optionally make non-public chargers available to the public.

This may improve the electric vehicle charging infrastructure.

### BRIEF DESCRIPTION OF THE FIGURES

FIG. 1 is a block diagram illustrating an electric vehicle charging system according to some exemplary embodiments.

FIG. 2 is a block diagram illustrating a configuration of a host terminal, a user terminal, and a charging point operator server according to some exemplary embodiments.

FIGS. 3A, 3B, and 3C are diagrams illustrating the number of chargers and average charging fee information provided by a host application according to some exemplary embodiments.

FIG. 4 is a flow chart illustrating the operations progressing in using a shared charger according to some exemplary embodiments.

FIG. 5 is a flow chart illustrating the operation of an electric vehicle charging system after charging is completed according to some exemplary embodiments.

FIG. 6 is a flow chart illustrating the operation of an electric vehicle charging system when the shared charger fails according to some exemplary embodiments.

### DETAILED DESCRIPTION

When an individual installs an electric charger on a private land and wants to share access to the electric charger, the electric charger may be operated in sharing mode. The individual who wishes to operate an electric charger in a sharing mode is called a host, and the host's electric charger is called a shared charger. The host may determine whether and when the shared charger is operated in the sharing mode, and may determine the charging policy in the sharing mode. An entity that wants to charge an electric vehicle is called a user, and an entity that installs and operates a public charger is called a charging point operator. As described below, a charging point operator may provide facilities to supply power to shared chargers and public chargers through electric power systems. An entity that generates electricity and supplies the generated electricity to the charging point operator through the electricity system is referred to as an electricity supplier.

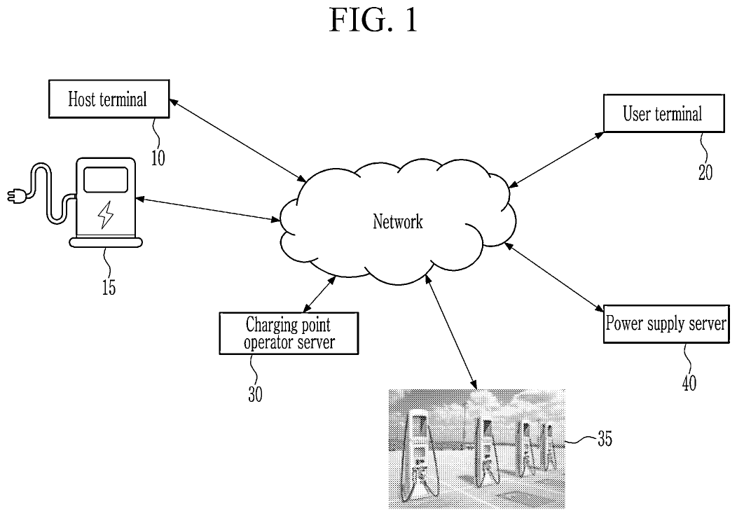

FIG. 1 is a block diagram illustrating an electric vehicle charging system according to some exemplary embodiments.

An electric vehicle charging system 1 includes a host terminal 10, a shared charger 15, a user terminal 20, a charging point operator server 30, a public charger 35, and a power supply server 40. The host terminal 10, the shared charger 15, the user terminal 20, the charging point operator server 30, the public charger 35, and the power supply server 40 are connected to each other via a network, and may send and receive necessary information.

The host terminal 10 is a terminal on which an application (hereinafter referred to as the host application) for operating the shared charger of the host is installed. The user terminal 20 is a terminal on which an application (hereinafter referred to as the charging application) for charging an electric vehicle by using a shared charger or a public charger is installed. The host terminal 10 and the user terminal 20 may be implemented as devices on which the application may be executed, such as a PC and a smartphone.

The charging point operator server 30 may operate the shared charger 15 and/or the public charger 35 based on information received from the host terminal 10 and/or the user terminal 20. The charging point operator may supply power to the shared charger 15 and the public charger 35, and the shared charger 15 and the public charger 35 may measure the amount of power used to charge the electric vehicle and transmit the measured amount of power to the charging point operator server 30. The public charger 35 is a charger installed by the charging point operator and, unlike the shared charger 15, does not operate in a non-public mode. That is, a user who wishes to charge an electric vehicle may use the public charger 35 without restriction.

The shared charger 15 may transmit a charger state to the charging point operator server 30. The state of the shared charger 15 may include charging standby, reservation standby, in-charging, charging complete, parked after full charging, and failure. Charging standby means that the shared charger 15 is in a standby state where the shared charger 15 is available for charging, reservation standby means that the shared charger 15 is in a standby state where there is a reservation for use of the shared charger 15, in-charging means that the shared charger 15 is charging an electric vehicle, charging complete means that the shared charger 15 has completed charging the electric vehicle, parking after full charge means that the electric vehicle is connected to the shared charger 15 after charging is complete, or the electric vehicle is parked within a predetermined range relative to the shared charger 15, and failure means that the shared charger 15 has detected an abnormality through diagnosis. The charging complete state may be set within a predetermined period from the time of charging completion, and the abnormality of the shared charger 15 may include an overvoltage, an overcurrent, an overheating state, and the like.

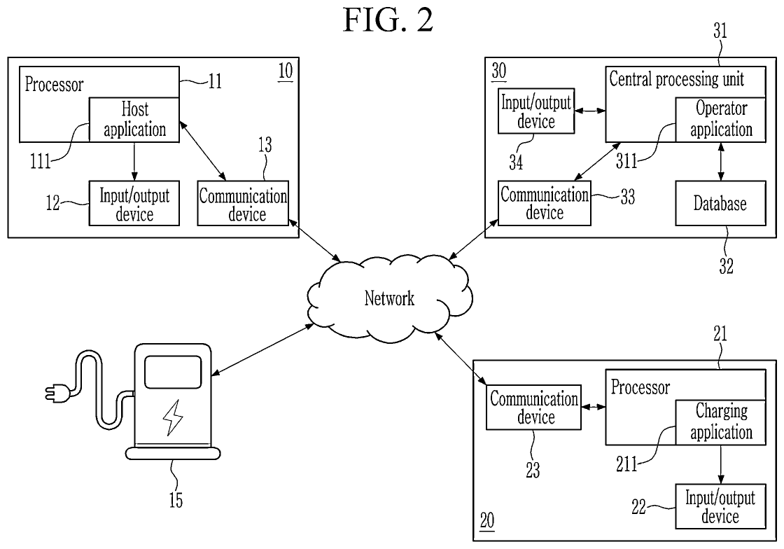

FIG. 2 is a block diagram illustrating the configurations of a host terminal, the user terminal, and the charging point operator server according to some exemplary embodiments.

The host terminal 10 may include a processor 11, an input/output device 12, and a communication device 13. The processor 11 is a configuration that controls the operation of the host terminal 10, which may be understood in the present specification primarily as a configuration that executes a host application 111. In the following, when the processor 11 executes the host application 111 to perform various information processing, the subject of the corresponding information processing operation may be the host application 111. The host application 111 may request and receive information from the charging point operator server 30 about the state of the shared charger 15, and may request and receive information from the charging point operator server 30 about charger usage charges incurred by using the shared charger 15, the host's profit from the charger usage charges, and the like. The host application 111 may transmit a request input by the host via the input/output device 12 to the charging point operator server 30 to receive a response to the request, and may display the received response via the input/output device 12.

The communication device 13 may provide information received from the outside via the network to the processor 11, or may transmit information provided by the processor 11 to the outside. Hereinafter, transmitting or receiving information by the host application 111 may be understood as transmitting information provided by the host application 111 to the outside via the communication device 13, or providing information received by the communication device 13 from the outside to the host application 111.

The input/output device 12 may image-process data provided from the processor 11 and display the processed data. The input/output device 12 may provide the input from the host to the processor 11.

The host application 111 may transmit host information to the charging point operator server 30. The host information may include information, such as the host's ID (cell phone number, email address, and the like), an account number for settling profit according to providing shared charging, information about the shared charger 15 (ID and location), and a business license number.

The host application 111 may control an operating mode of the shared charger 15. As shown in FIG. 2, when the host application 111 specifies the operating mode of the shared charger 15 as a non-public mode, the shared charger 15 does not charge any electric vehicle other than the host's electric vehicle. In this case, the host may pay the charging point operator a base fee established by the charging point operator. When the host application 111 specifies the operating mode of the shared charger 15 as a sharing mode, the shared charger 15 may be utilized to charge the electric vehicles of others (users) other than the host. The host application 111 may also control the on/off of the shared charger 15. The host application 111 may obtain various information, such as information about the electric vehicle to be charged with the shared charger 15, information about the user, information about the charger usage fee, and information about the amount of charging power, through communicate with the charging point operator server 30, and display the obtained information via the input/output device 12.

The user terminal 20 may include a processor 21, an input/output device 22, and a communication device 23. The processor 21 is a configuration that controls the operation of the user terminal 20, which may be understood in the present specification primarily as a configuration that executes a charging application 211. In the following, when the processor 21 executes the charging application 211 to perform various information processing, the subject of the information processing operation may be the charging application 211.

The communication device 23 may provide the processor 21 with information received from the outside via the network, or may transmit information provided by the processor 21 to the outside. Hereinafter, transmitting or receiving information by the charging application 211 may be understood as transmitting information provided by the charging application 211 to the outside via the communication device 23, or providing information received by the communication device 23 from the outside to the charging application 211.

The input/output device 22 may image-process data provided from the processor 21 and display the processed data. The input/output device 22 may provide input from the user to the processor 21.

The charging application 211 may provide user information to the charging point operator server 30. The user information may include a user's ID (for example, cell phone number or email address), an account or a credit card to pay for charger usage fee, and the like.

The charging application 211 may receive information about shared chargers and/or public chargers from the charging point operator server 30 or a specific server and display the received information on the I/O device 22. The information about the shared chargers and/or public chargers may include information, such as the type (slow, fast, combined slow/fast) and state of each of the shared chargers and/or public chargers, the distance to each of the shared chargers and/or public chargers from a specific reference location (for example, a user's current location), and the charging fee per unit of power (KRW/kW). The charging application 211 may search for shared chargers and/or public chargers, and may provide information about the searched shared chargers and/or public chargers to the user, to allow the user to select one of the shared chargers and/or public chargers. Further, the user may request the charging point operator server 30 to change a shared charger in the non-public mode to the sharing mode via the charging application 211. The charging application 211 may receive a response to the request from the charging point operator server 30 and display the received response via the I/O device 22. In addition, the charging application 211 may receive information about an electric vehicle and transmit the received information to the charging point operator server 30.

The charging point operator server 30 may include a central processing unit 31, a communication device 32, a database 33, and an input/output device 34. The central processing unit 31 may collect and process information about the shared chargers and/or public chargers covered by the charging point operator server 30 and store the processed information in the database 33. The central processing unit 31 may execute an operator application 311 to provide the charging application 211 with a search for shared chargers and/or public chargers, and may provide charging and payment for usage fee for the shared chargers or public chargers used for charging. In the present specification, the central processing unit 31 may be understood as a configuration that primarily executes the operator application 311. In the following, when the central processing unit 31 executes the operator application 311 to perform various information processing, the subject of the corresponding information processing operation may be the operator application 311.

The communication device 32 may provide information received from the outside via the network to the central processing unit 31, or may transmit information provided by the central processing unit 31 to the outside. Hereinafter, transmitting or receiving information by the operator application 311 may be understood as transmitting information provided by the operator application 311 to the outside via the communication device 32, or providing information received by the communication device 32 from the outside to the operator application 311.

The database 33 may store and manage information written by the central processing unit 31. For example, the database 33 may store data provided with a store instruction from the operator application 311, or may read data provided with a read instruction and provide the read data to the operator application 311.

The input/output device 34 may image-process data provided from the central processing unit 31 and display the processed data. The input/output device 34 may provide input from the charging point operator to the central processing unit 31. The charging point operator may input information about the base fee into the central processing unit 31 via the input/output device 34.

The power supply server 40 may calculate an electricity charge based on the amount of power supplied to the charging point operator, transmit the calculated electricity charge to the charging point operator server 30, and charge the electricity charge. Account information for charging may be transmitted by the charging point operator server 30 to the power supply server 40.

In the present disclosure, the shared charger 15 may operate in a non-public mode and a sharing mode. The shared charger 15 is purchased by a host, the host takes ownership of the shared charger 15, and the shared charger 15 is installed on the host's private land. When the shared charger 15 operates in the non-public mode, the host is free to use the shared charger 15 whenever he/she wants and is not obligated to allow others to use the shared charger 15. The way of operating the shared charger 15 as a he non-public charger is referred to as the non-public mode. Conversely, the host may make the shared charger 15 available for use by others, and the host allows others to use the shared charger 15 for a specified period of time, which is referred to as the sharing mode. A third party may make a request to the charging point operator server 30 for use of the shared charger 15 to charge the electric vehicle of the user at a specific time for the shared charger 15 operating in the sharing mode, and in response to the request, the user may be allowed to use the shared charger 15. As described above, the way of operating the shared charger 15 during the time allowed by the host is referred to as the sharing mode.

In the sharing mode, a portion of the charger usage charge for the shared charger 15 paid by the user is provided to the host. A shared charging fee per unit of power (KRW/kW, hereinafter referred to as the “shared charging fee”) generated by the use of the shared charger 15 according to some exemplary embodiments includes a base fee per unit of power (KRW/kW, hereinafter referred to as the “base fee”) for the charging point operator and an additional fee per unit of power (KRW/kW, hereinafter referred to as the “additional fee”) to the host. The user may pay the shared charging fee to the charging point operator, and the charging point operator may provide a portion of the paid shared charging fee to the host. The host may set the additional fee via the host application 111. In this case, the additional fee may be in a range set by the charging point operator. For example, the host may receive a range for the additional fee from the charging point operator server 30 via the host application 111, and may set the additional fee within the corresponding range and transmit the set additional fee to the charging point operator server 30. After the additional fee is set, the frequency of changes to the additional fee is subject to a set regulation, which may be regulated by a power provider or the like.

The host may purchase a charging platform from the charging point operator and install the purchased charging platform on a private land. The charging platform may include a charger for charging the electric vehicle and wires from the power system to supply power to the charger. The host must pay for the cost of the charger, the installation and construction fee to install the charger, and the electrical work fee to connect the wires between the power system and the charger. The charging point operator may assist the host with at least one of the installation and construction fee and the electrical work fee. The charging point operator may purchase chargers from charger manufacturers and sell the chargers to hosts, or may manufacture chargers themselves and sell the manufactured chargers to hosts. The charging point operator may pay a fee based on the amount of power supplied by the electricity supplier, and may charge the charging fee to users who use the shared charger 15 and the public charger 35 and receive payment from the users.

The host may set and transmit additional fees to the charging point operator server 30 via the host application 111. For example, when the base fee is 250 KRW per 1 kilowatt-hour (kW) and the additional fee is 150 KRW per 1 kW, the shared charging fee may be 400 KRW per 1 kW. In this case, the charging point operator may have a 90% share and the host may have a 10% share in the base profit obtained by subtracting the electricity fee payable to the electricity supplier from the base fee. For the additional fee, the charging point operator may have a 20% share and the host may have an 80% share. When the electricity fee that the charging point operator must pay to the electricity supplier is 100 KRW/kW, the charging point operator may earn 165 KRW/kW, which is the sum of 150 (=250−100) KRW/kW*0.9 for the base profit and 150 KRW/kW*0.2 for the additional fee, and the host may earn 135 KRW/kW, which is the sum of 150 (=250−100) KRW/kW*0.1 for the base profit and 150 KRW/kW*0.8 for the additional fee. The additional fee of 150 KRW/kW may be an amount that falls within a predetermined additional fee range provided to the host terminal 10 by the charging point operator server 30.

The share ratio between the charging point operator and the host may be designed by the charging point operator, and the charging point operator may set the designed share ratio on the charging point operator server 30. The charging point operator may obtain information about electricity fees from an electricity supplier, determine a base fee based on the charging point operator's profit margin and electricity fee, and set the determined base fee on the charging point operator server 30.

The host may change the shared charger 15 from the non-public mode to the sharing mode, or change the shared charger 15 from the sharing mode to the non-public mode, via the host application 111. The host application 111 may request a charging fee recommendation from the charging point operator server 30 in response to change the operation mode of the shared charger 15 to the sharing mode. Alternatively, without a request from the host application 111, when the charging point operator server 30 receives information from the host application 111 about the change of the operation mode of the shared charger 15 to the sharing mode, the charging point operator server 30 may generate recommended charging fee information and transmit the recommended charging fee to the host application 111.

The charging point operator server 30 may search for shared and/or public chargers (hereinafter referred to as minimum distance chargers) of the same type (for example, slow chargers or fast chargers) as the shared charger 15 that are located within a minimum distance R_min relative to the shared charger 15, and calculate the number of searched minimum distance chargers, and an average (hereinafter, referred to as a first average fee) of the usage fees of the minimum distance chargers. In this disclosure, “radius” may be used as an example of “distance.” That is, the charging point operator server 30 may search for minimum distance chargers of the same type as the shared charger 15 that are located within a minimum radius R_min relative to the shared charger 15.

The charging point operator server 30 may transmit the number of minimum distance chargers and the first average fee to the host terminal 10. The minimum distance R_min may be set by the charging point operator. For example, the minimum distance R_min may be set to a distance within which a user parks to charge an electric vehicle with a charger, walks to a user's primary location, and waits for the charging period. The user's primary location may mean a location where the user is comfortable waiting during the charging period, such as the user's home or office.

The charging point operator server 30 may search for shared and/or public chargers (hereinafter referred to as maximum distance chargers) of the same type as the shared charger 15 that are located within a maximum distance R_max exceeding the minimum distance R_min relative to the shared charger 15, and calculate the number of searched maximum distance chargers, and an average (hereinafter, referred to as a second average fee) of the usage fees of the maximum distance chargers. The charging point operator server 30 may transmit the number of maximum distance chargers and the second average fee to the host terminal 10. The maximum distance R_max may be set by the charging point operator. For example, the maximum distance R_max may be the psychological tolerance distance that a user may reach by driving the electric vehicle to charge. That is, the user may select a charger within the maximum distance R_max even if a unit charging fee of a charger located outside the maximum distance R_max is lower than a unit charging fee of a charger within the maximum distance R_max by a predetermined reference amount or more.

The charging point operator server 30 may calculate a recommended charging fee using the first average fee and a distance weighted value for the minimum distance chargers, and the second average fee and a distance weighted value for the maximum distance chargers. For example, the charging point operator server 30 may calculate the recommended charging fee based on (AP1*W1)+(AP2*W2), which is the result of a value (AP1*W1) obtained by multiplying the first average fee AP1 by the first distance weighted value W1 for the minimum distance and a value (AP2*W2) obtained by multiplying the second average fee AP2 by the second distance weighted value W2 for the maximum distance. The first distance weighted value W1 may have a value greater than the second distance weighted value W2.

The charging point operator server 30 may transmit the calculated charging fee to the host terminal 10. The host application 111 may provide display data indicating the recommended charging fee received by the host terminal 10 to the input/output device 12, and the input/output device 12 may display the recommended charging fee. The recommended charging fee provided by the charging point operator server 30 may be considered by the host. That is, the host may input an additional fee via an additional fee input screen provided to the host terminal 10 by the host application 111 in consideration of the recommended charging fee. However, it should be noted that the charging fee recommended by the charging point operator server 30 is only for consideration by the host and is not enforceable.

The host application 111 may progressively in stages, via the input/output device 12, information on the number of chargers and the average charging fee within the minimum distance, the information on the number of chargers and the average charging fee within the minimum distance to the maximum distance, and finally the recommended charging fee information.

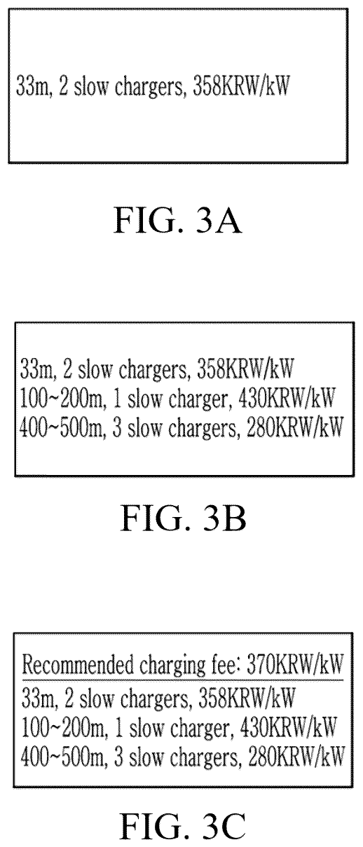

FIG. 3 is a diagram illustrating the number of chargers and average charging fee information provided by a host application according to some exemplary embodiments.

Assuming that the shared charger 15 is a slow charger, the charging point operator server 30 may only search for slow chargers to calculate the recommended charging fee. It is assumed that a minimum distance is 100 m and a maximum distance is 500 m.

First, as shown in FIG. 3A, the host application 111 may indicate via the input/output device 12 that there are two slow chargers within a minimum distance of 100 m from the shared charger 15, and that the average charging fee of the two slow chargers is 358 KRW/kW.

Next, as shown in FIG. 3B, the host application 111 may display, via the input/output device 12, the number of slow chargers and the average charging fee of the slow chargers in the unit of 100 m within a minimum distance of 100 m to a maximum distance of 500 m from the shared charger 15, along with the contents shown in (a) of FIG. 3. For example, there may be displayed the fact that there is one slow charger in the range of 100 to 200 m and a charging fee is 430 KRW/kW, and there are two slow chargers in the range of 400 to 500 m and an average charging fee is 280 KRW/kW.

Finally, as shown in C, the host application 111 may display a recommended charging fee of 370 KRW/kW via the input/output device 12 along with the contents shown in FIGS. 3A and 3B.

In this way, the number of chargers located within a predetermined range relative to the shared charger 15, the average charging fee, and the recommended charging fee may be displayed via the input/output device 12, in stages in the order of (a), (b), and (c) of FIG. 3.

The host may determine the value of 120 KRW/kW that is obtained by subtracting the base fee, for example, 250 KRW/kW, from the recommended charging fee of 370 KRW/kW as an additional fee, and input the additional fee of 120 KRW/kW into an additional fee input window provided by the host application 111. Alternatively, the host may accept the recommended charging fee or input a different amount of charging fee into the host application 111 instead of the recommended charging fee, and the host application 111 may calculate the additional fee by subtracting the base fee from the corresponding charging fec. As previously mentioned, the host only takes into account the recommended charging fee, but may input an additional fee at a different amount from 120 KRW/kW. The host may determine the amount of 120 KRW/kW or lower as the additional fee when the host wants to actively encourage the use of the shared charger 15, and conversely, the host may determine the amount of 120 KRW/kW or higher as the additional fee. When the charging point operator server 30 receives the information about the additional fee from the host application 111, the charging point operator server 30 may finally determine a shared charging fee. The shared charging fee may refer to a fee per kW.

The host application 111 may receive a request (hereinafter, a sharing change request) of a user who wants to use the shared charger 15 from the charging point operator server 30, and display the request via the input/output device 12. The host application 111 may also receive the sharing change request directly from the user terminal 20. In this case, the host application 111 may transmit the sharing change request from the user terminal 20 to the charging point operator server 30. When the charging point operator server 30 receives the sharing change request, the charging point operator server 30 may request information about the amount of charging power from the shared charger 15. The shared charger 15 may transmit information about the amount of charging power when the charging is completed to the charging point operator server 30 as the response to the request.

The host application 111 of the user may obtain the state of the shared charger 15 from the charging point operator server 30 in real time and display the obtained state on the input/output device 12. This allows the host to monitor the state of the shared charger 15. Further, the host application 111 may obtain profit information about the profit earned by the shared charger 15 operating in the sharing mode from the charging point operator server 30, and display the profit information via the input/output device 12.

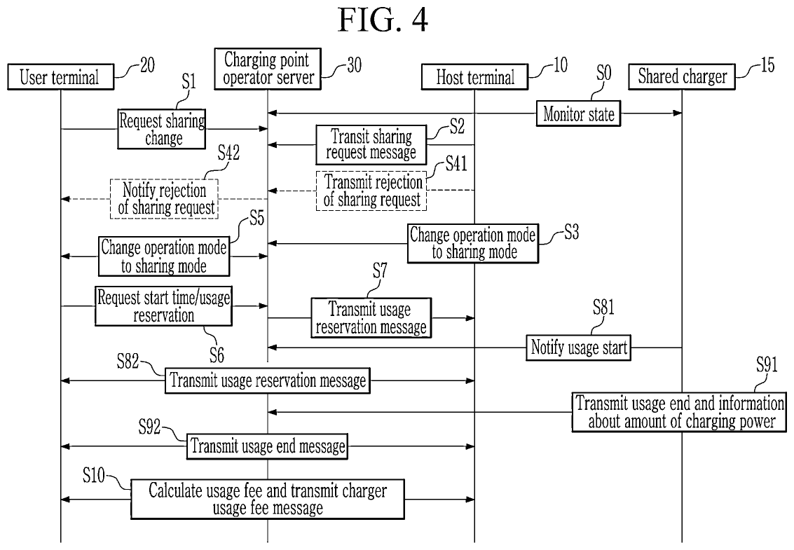

FIG. 4 is a flow chart illustrating the operations progressing in using the shared charger according to some exemplary embodiments.

As shown in FIG. 4, the charging point operator server 30 may monitor the state of the shared charger 15 in real time (S0). The charging point operator server 30 may request state information from the shared charger 15, and the shared charger 15 may transmit a current state to the charging point operator server 30 in response to the request.

A sharing change request for the shared charger selected by the user may be transmitted from the user terminal 20 to the charging point operator server 30 (S1). In this case, the operating mode of the shared charger may be a non-public mode. The user may search for shared chargers and/or public chargers stored in a specific database through a charging application installed on the user terminal 20, or may search for shared chargers and/or public chargers through the charging point operator server 30. In this case, the specific database may be a database of a server that stores/manages/updates information about shared chargers and public chargers, such as a database of the Ministry of Environment. The user may select one of the searched shared chargers and/or public chargers. In the present specification, it is described that the charger selected by the user is the shared charger 15.

The charging point operator server 30 may receive the sharing change request, and may transmit a sharing request message to the host terminal 10 corresponding to the shared charger 15 (S2).

When the host application 111 receives a sharing mode change from the host in response to the received sharing request message, the host application 111 may notify the charging point operator server 30 that the operating mode of the shared charger 15 has been changed to the sharing mode (S3). When a rejection of the sharing change request from the host is input, or when no sharing mode change input is received within a predetermined time period, the host application 111 may transmit a rejection of the sharing request to the charging point operator server 30 (S41). The charging point operator server 30 may notify the user terminal 20 of the received rejection of the sharing request (S42).

Following step S3, the charging point operator server 30 may transmit a sharing mode changing message to the user terminal 20 (S5). The user may request a usage reservation with a usage start time for the shared charger 15 to the charging point operator server 30 via the charging application on the user terminal 20 (S6). After the operating mode of the shared charger 15 is changed to the sharing mode of the shared charger 15, when the current electric vehicle of the user is being charged and a next user wishes to reserve the use of the shared charger 15, the charging point operator server 30 may obtain a charging end prediction time via wireless communication with the current electric vehicle of the user. The charging point operator server 30 may transmit the obtained charging end prediction time to the terminal of the next user, and the charging application installed on the terminal of the next user may display the charging end prediction time so that the next user may determine the reservation time.

The charging point operator server 30 may transmit information about the usage start time and the usage reservation to the host terminal 10 as a usage reservation message (S7).

When the user starts charging using the shared charger 15, the shared charger 15 may transmit information about the usage start to the charging point operator server 30 (S81), and the charging point operator server 30 may transmit a usage start message to the host terminal 10 (S82). Alternatively, the shared charger 15 may transmit the information about the usage start to the charging point operator server 30 and the host terminal 10.

When the user ends the charging using the shared charger 15, the shared charger 15 may transmit information about the usage end and the amount of power charged to the charging point operator server 30 (S91), and the charging point operator server 30 may transmit the usage end message to the host terminal 10 (S92). Alternatively, the shared charger 15 may transmit information about the usage end to the charging point operator server 30 and the host terminal 10.

The charging point operator server 30 may calculate a charger usage fee based on the amount of power charged and the shared charging fee, and may transmit the charger usage fee as a message to the host terminal 10 and the user terminal 20 (S10).

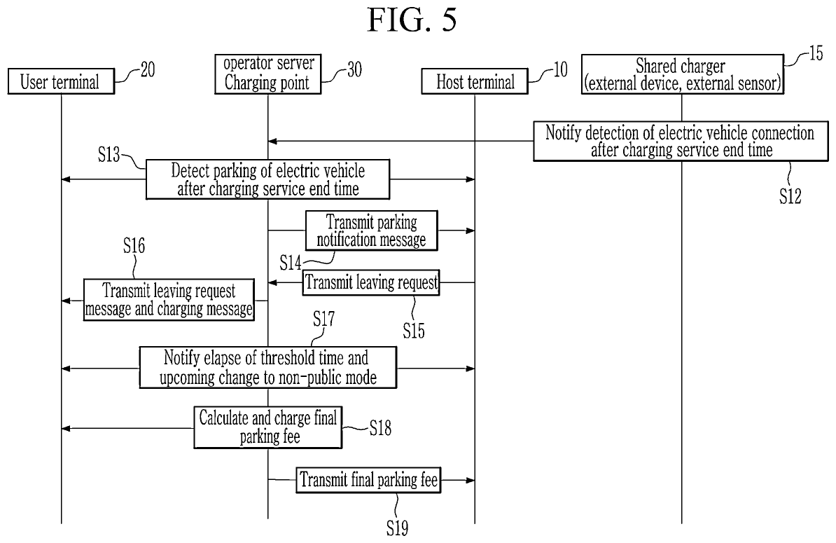

FIG. 5 is a flow chart illustrating the operation of an electric vehicle charging system after charging is completed according to some exemplary embodiments.

After the charging is completed, the electric vehicle of the user may be parked within a predetermined range (hereinafter, the charging area) relative to the shared charger 15. When the electric vehicle is connected to the shared charger 15 after a predetermined time (hereinafter, the charging service end time) elapses from the time of charging completion, the shared charger 15 may detect the connection of the electric vehicle and notify the charging point operator server 30 of the detected connection of the electric vehicle (S12). The charging point operator server 30 may determine that the electric vehicle is being parked in the charging area while the electric vehicle is connected after the charging service end time. Alternatively, the charging point operator server 30 may receive images of the charging area from an external device, such as a camera or CCTV, and analyze the received images to determine whether the electric vehicle is parked after the charging time. Alternatively, the charging point operator server 30 may receive a detection result from an external sensor that detects the presence of an object in the charging area, and determine whether the electric vehicle is parked after the charging time.

The charging point operator server 30 may detect that the electric vehicle of the user is parked in the charging area after the charging service end time (S13).

When the charging point operator server 30 detects parking after the charging service end time, the charging point operator server 30 may transmit a parking notification message to the host terminal 10 indicating that the electric vehicle of the user is being parked after the charging is completed (S14).

The host application 111 may transmit a leaving request to the charging point operator server 30 (S15).

The charging point operator server 30 may transmit a leaving request message and a charging alarm message indicating that the parking fee may be charged to the user terminal 20 (S16).

The charging point operator server 30 may count the time that the electric vehicle of the user is parked from the charging completion time. When the parking time reaches a threshold time, the charging point operator server 30 may notify the host terminal 10 and the user terminal 20 that the threshold time has elapsed and that the operation of the shared charger 15 is about to change to the non-public mode (S17).

The charging point operator server 30 may calculate a final parking fee by counting the parking time from the charging service end time to the time that the electric vehicle of the user leaves, and may charge the calculated final parking fee (S18). The charging point operator server 30 may charge the final parking fee according to the user's payment information via the account or credit card from which the charger usage fee is paid.

The charging point operator server 30 may transmit the final parking fee to the host terminal 10 (S19).

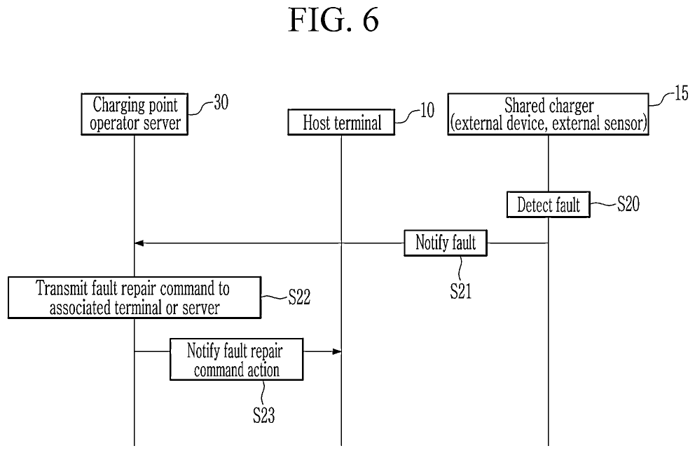

FIG. 6 is a flow chart illustrating the operation of the electric vehicle charging system when the shared charger fails according to some exemplary embodiments.

The shared charger 15 may detect a fault through diagnosis (S20). For example, the shared charger 15 may diagnose a fault when at least one of a charging current, a charging voltage, and a temperature of the charger is equal to or greater than a corresponding threshold.

The shared charger 15 may notify the detection of the fault to the charging point operator server 30, or to the charging point operator server 30 and the host terminal (S21).

When the charging point operator server 30 receives a fault notification, the charging point operator server 30 may transmit a fault repair command to the associated terminal or server (S22). If the charging point operator is able to provide fault repair, the charging point operator server 30 may transmit the fault repair command to the terminal of the employee responsible for the shared charger 15. When there is a separate company that repairs charger faults other than the charging point operator, the charging point operator server 30 may transmit the fault repair command to a server of the corresponding company.

When the charging point operator server 30 transmits the fault repair command, the charging point operator server 30 may notify the host terminal 10 that the fault repair command has been acted (S23).

In the exemplary embodiments described so far, a host may purchase and install a non-public charger on a private land, and freely charge the electric vehicle and change the non-public charger to the sharing mode during periods of non-use to earn profit. Then, the host may recover the cost of purchasing/installing the charger and earn a profit continuously. In addition, the charger usage fee may be shared between the host and the charging point operator, not only the host but also the charging point operator that provides the charging platform may earn profits. The profit generated from sharing the non-public charger may encourage more hosts to install chargers, which may improve charging infrastructure.

In addition, chargers may be deployed in places where a charging infrastructure was not previously available, thereby providing users who drives electric vehicles with the convenience of charging their electric vehicles. Users want to use chargers that are relatively close to user's current locations. Especially in the case of slow charging, the time required for charging is long, and even though the charging fee is expensive, when the charging fee is within a certain limit, the user prefers a charger close to a place where the user may wait comfortably. Therefore, when the number of chargers of hosts located in urban centers is increased according to the present disclosure, the convenience of charging for users may be increased.

Furthermore, according to the exemplary embodiments of the present disclosure, when the electric vehicle is parked within the charging area after charging is complete, the fact that parking fee may be incurred may be informed to the user and then the parking fee may be collected from the user. Thus, the host may earn not only the charging fee but also the parking fee during the parking time after full charging as profits. This prevents users from not leaving in time after charging completion to cause damage to the host, and encourages users to leave quickly after charging completion, to increase the number of electric vehicles charged in the sharing mode.

The most problematic aspect of installing slow chargers to promote charging infrastructure supply activation is the cost, such as purchase cost and installation cost. Business operators, such as self-employed entrepreneurs operating restaurants, shops, or the like, and accommodation agents operating pensions, hotels, motels, and the like may install non-public chargers in their parking lots for visiting customers and operate the non-public chargers in the sharing mode during times when the non-public chargers are available for sharing, thereby earning profits and solving cost concerns.

In conventional charger sharing methods, there are complex time setting issues, such as requesting reservation between hosts and users, setting usage time, or changing availability time. The present disclosure enables simple time-setting by allowing the host to change a non-public charger to a sharing mode at a desired time. The host may restrictively open the private land only in the sharing mode while freely using the charger. The host may obtain market price information about the surrounding fees from the charging point operator, so the host may set an appropriate additional fee to ensure profits.

When a charging point operator does not make much profit from purchasing and installing the non-public charger, the charging point operator may not be active to supply the non-public charger. According to the present disclosure, the charging point operator may earn profits from the sharing of non-public chargers, which may encourage the charging point operator to active to supply non-public chargers.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

1. An electric vehicle charging system, the electric vehicle charging system comprising:
a host terminal on which a host application that receives instructions on an operating mode of a shared charger and an additional fee for use of the shared charger is installed; and
a charging point operator server configured to calculate a charger usage fee based on a shared charging fee obtaining by adding a predetermined base fee to the additional fee provided from the host terminal, and a usage time of the shared charger by a user;
wherein the charging point operator server receives, from a user terminal of the user, a sharing change request requesting a change of an operating mode of the shared charger to a sharing mode in which a public charger is available to the user, and transmits the sharing change request to the host terminal.

2. The electric vehicle charging system of claim 1, wherein:
the charging point operator server is configured to search for minimum distance chargers, which are shared or public chargers located within a predetermined minimum distance relative to the shared charger, to calculate a number of minimum distance chargers searched and a first average fee for the usage fees of the minimum distance chargers, to search for maximum distance chargers, which are shared or public chargers located within a predetermined maximum distance exceeding the predetermined minimum distance relative to the shared charger, to calculate the number of maximum distance chargers searched and a second average fee for usage fees for the maximum distance chargers, and to calculate a recommended charging fee based on the first average fee and the second average fee and transmit the recommended charging fee to the host terminal.

3. The electric vehicle charging system of claim 2, wherein:
the charging point operator server is further configured to calculate the recommended charging fee by using the first average fee and a first distance weighted value for the minimum distance chargers, and the second average fee and a second distance weighted value for the maximum distance chargers.

4. The electric vehicle charging system of claim 3, wherein:
the charging point operator server is further configured to calculate the recommended charging fee by adding a value obtained by multiplying the first average fee by the first distance weighted value and a value obtained by multiplying the second average fee by the second distance weighted value; and
the first distance weighted value is greater than the second distance weighted value.

5. The electric vehicle charging system of claim 2, wherein:
the host application, via an input/output device of the host terminal, displays in stages, the number of minimum distance chargers searched and the first average fee, a number of maximum distance chargers searched and the second average fee, and the recommended charging fee.

6. The electric vehicle charging system of claim 1, wherein the charging point operator server is further configured to:
set a share of a first ratio and a share of a second ratio for the predetermined base fee and the additional fee as a profit of the charging point operator server; and
set a share of a third ratio and a share of a fourth ratio for the predetermined base fee and the additional fee as a profit of the host terminal;
wherein a sum of the first ratio and the third ratio is 1, and a sum of the second ratio and he fourth ratio is 1.

7. The electric vehicle charging system of claim 1, wherein:
when an operating mode for the shared charger is a non-public mode, the charging point operator server receives the sharing change request from the user terminal, and transmits a sharing request message to the host terminal in response to the sharing change request.

8. The electric vehicle charging system of claim 7, wherein:
when a sharing mode change is received from the host terminal in response to the sharing request message, the charging point operator server transmits a sharing mode changing message to the user terminal.

9. An electric vehicle charging method of providing electric vehicle charging by using a shared charger installed by a host, the electric vehicle charging method comprising:
monitoring, by a charging point operator server, a state of the shared charger;
when receiving a sharing change request for the shared charger from a user terminal, transmitting, by the charging point operator server, a sharing request message to a host terminal;
receiving, by the charging point operator server, a sharing mode change from the host terminal, and transmitting a sharing mode change message to the user terminal;
receiving, by the charging point operator server, a usage start time and a usage reservation request from the user terminal;
receiving, by the charging point operator server, information about a charging start from the shared charger, and transmitting a usage start message to the host terminal;
receiving, by the charging point operator server, information about a usage end and an amount of charging power from the shared charger; and
calculating, by the charging point operator server, a charger usage fee based on the amount of charging power and a shared charging fee.

10. The electric vehicle charging method of claim 9, further comprising:
transmitting, by the charging point operator server, information about the usage start time and the usage reservation request to the host terminal.

11. The electric vehicle charging method of claim 9, further comprising:
transmitting, by the charging point operator server, the charger usage fee to the host terminal and the user terminal in a form of a message.

12. The electric vehicle charging method of claim 9, further comprising:
detecting, by the charging point operator server, that an electric vehicle of a user is being parked in a charging area after a charging service end time that is elapsed by a predetermined time from a charging completion time;
transmitting, by the charging point operator server, a parking notification message indicating that the electric vehicle of the user is being parked after charging is completed to the host terminal; and
receiving, by the charging point operator server, a leaving request from the host terminal, and transmitting a leaving request message and a charging alarm message indicating that a parking fee is possibly charged to the user terminal.

13. The electric vehicle charging method of claim 9, further comprising:
when a parking time reaches a threshold time, notifying by the charging point operator server, the host terminal and the user terminal that the threshold time has elapsed and that a change to a non-public mode is to be made;
calculating, by the charging point operator server, a final parking fee by counting a parking time of the electric vehicle of a user from a charging service end time to the time the electric vehicle of the user leaves, and charging the user for the final parking fee; and
transmitting, by the charging point operator server, the final parking fee to the host terminal.

14. The electric vehicle charging method of claim 9, further comprising:
receiving, by the charging point operator server, a fault detection from the shared charger; and
transmitting, by the charging point operator server, a fault repair command for the shared charger to an associated terminal or server.
